(19) United States
(12) Patent Application Publication
(10) Pub. No.: US 2016/0147561 A1
(43) Pub. Date: May 26, 2016

(54) INFORMATION PROCESSING METHOD AND INFORMATION PROCESSING SYSTEM

(71) Applicant: HITACHI, LTD., Tokyo (JP)

(72) Inventors: Masahiro MURATA, Tokyo (JP); Kazuhiro SATOU, Tokyo (JP); Tetsuya HAYASHI, Tokyo (JP); Hiroshi SHIMIZU, Tokyo (JP)

(21) Appl. No.: 14/900,255

(22) PCT Filed: Mar. 5, 2014
(86) PCT No.: PCT/JP2014/055628

§ 371 Date: Dec. 21, 2015

(51) Int. Cl. G06F 9/46; G06F 9/50

(52) U.S. Cl. CPC G06F 9/466; G06F 9/5011

(57) ABSTRACT

A job management unit manages a registered job by associating the job with an identifier specific to the job and reports a request to execute the job and the identifier associated with the job to a job execution unit on an execution date and time of the job; and the job execution unit manages a generation file of a next generation, which is created by executing the job, by associating the generation file with the identifier reported together with the request to execute the job from the job management unit; and if the generation file associated with the identifier reported together with the execution request already exists when executing the job based on the execution request from the job management unit, the job execution unit executes designated operation.

### TECHNICAL FIELD

The present invention relates to an information processing method and an information processing system and is suited for use in an information processing system equipped with a generation management file function.

### BACKGROUND ART

A function that manages a series of files, which are temporally related to each other like the relationship between old files and new files of sequentially-updated files, such as salary files and inventory files, as a group is called a generation file function. This group will be hereinafter referred to as a “generation group” and individual files which constitute a generation group will be referred to as “generation files.”

When the conventional generation file function is used for processing composed of a series of jobs, it is a common operation to input the latest generation file and create a new generation file. If there is a possibility that the content of a generation file created by, for example, a job error might have become invalid as a result of such operation, it is necessary to re-execute the job in order to re-create the generation file.

### CITATION LIST

### Patent Literature

[PTL 1] Japanese Patent Application Laid-Open (Kokai) Publication No. 2008-236653

### SUMMARY OF INVENTION

### Problems to be Solved by the Invention

However, the conventional generation file function does not manage which generation file is created by which job. Therefore, if a job is re-executed, a generation file of the next generation will be created unconditionally regardless of whether that job has already output a generation file or not.

If so, as a result of re-executing the job, an invalid generation file created due to, for example, a job error is input and a generation file of one generation after the targeted generation will be created and generation management information which manages generation files and generations will become inconsistent.

Therefore, conventionally, when re-executing a job it is necessary to, for example, execute processing for deleting an invalid generation file created due to a job error and a generation file created by inputting the above-mentioned generation file (post-processing for the invalid generation file) and modify a job execution plan to decide which generation file is to be input to create a generation file of the targeted generation, with respect to the generation for which the invalid generation file has been created due to the job error (modification of the job execution plan) (see, for example, PTL 1); and there is a problem of an increase in time required to complete a series of jobs.

The present invention was devised in consideration of the above-described circumstances and aims at proposing an information processing method and information processing system capable of reducing costs of the post-processing of invalid generation files caused by a job error and the modification of the job execution plan and shortening time required to complete the processing composed of a series of jobs.

### Means for Solving the Problems

In order to solve the above-described problems, provided according to the present invention is an information processing method for an information processing system which creates, by inputting a generation file of a latest generation and executing a job, a generation file of a next generation, the information processing system comprising: a job management unit that manages the job which is registered; and a job execution unit that executes the job designated on the basis of a request to execute the job from the job management unit, the information processing method comprising: a first step executed by the job management unit managing the registered job by associating the job with an identifier specific to the job and reporting a request to execute the job and the identifier associated with the job to the job execution unit on an execution date and time of the job; and a second step executed by the job execution unit executing the job designated on the basis of the request to execute the job from the job management unit and managing the generation file of the next generation created by executing the job by associating the generation file with the identifier reported together with the request to execute the job from the job management unit; wherein in the second step, the job execution unit checks, when executing the job on the basis of the execution request from the job management unit, whether the generation file associated with the identifier reported together with the execution request already exists or not; and the job execution unit executes the designated job if the generation file does not exist; and the job execution unit executes designated operation if the generation file already exists.

Furthermore, provided according to the present invention is an information processing system which creates, by inputting a generation file of a latest generation and executing a job, a generation file of a next generation, the information processing system comprising: a job management unit that manages the job which is registered; and a job execution unit that executes the job designated on the basis of a request to execute the job from the job management unit, wherein the job management unit manages the registered job by associating the job with an identifier specific to the job and reports a request to execute the job and the identifier associated with the job to the job execution unit on an execution date and time of the job; and wherein the job execution unit manages the generation file of the next generation created by executing the job by associating the generation file with the identifier reported together with the request to execute the job from the job management unit; and the job execution unit checks, when executing the job on the basis of the execution request from the job management unit, whether the generation file associated with the identifier reported together with the execution request already exists or not; and the job execution unit executes the designated job if the generation file does not exist; and the job execution unit executes designated operation if the generation file already exists.

This information processing method and information processing system can prevent a new generation file from being created unconditionally by re-executing a job.

### Advantageous Effects of Invention

According to the present invention, the costs of the post-processing of invalid generation files caused by job errors and the modification of the job execution plan can be reduced and, therefore, the time required to complete the processing composed of a series of jobs can be shortened.

### BRIEF DESCRIPTION OF DRAWINGS

FIG. 1 is a block diagram illustrating a hardware configuration of an information processing system according to this embodiment;

FIG. 2 is a block diagram illustrating a logical configuration of the information processing system according to this embodiment;

FIG. 3 is a conceptual diagram illustrating the structure of a job management table;

FIG. 4 is a conceptual diagram illustrating the structure of a generation management file;

FIG. 5 is a block diagram for explaining the processing content of an execution control unit upon normal batch processing;

FIG. 6 is a block diagram for explaining the processing content of the execution control unit upon re-execution of the batch processing;

FIG. 7 is a block diagram for explaining the processing content of the execution control unit upon re-execution of the batch processing;

FIG. 8 is a schematic diagram schematically illustrating a screen configuration example of a job net screen;

FIG. 9 is a schematic diagram illustrating a configuration example of a first operation check window;

FIG. 10 is a schematic diagram illustrating a configuration example of a second operation check window;

FIG. 11 is a flowchart illustrating a processing sequence example of job boot processing;

FIG. 12 is a flowchart illustrating a processing sequence example of job management processing;

FIG. 13A is a flowchart illustrating a processing sequence example of job execution control processing; and

FIG. 13B is a flowchart illustrating a processing sequence example of the job execution control processing.

### MODE FOR CARRYING OUT THE INVENTION

An embodiment of the present invention will be described below in detail with reference to the drawings.

### (1) Configuration of Information System According to this Embodiment

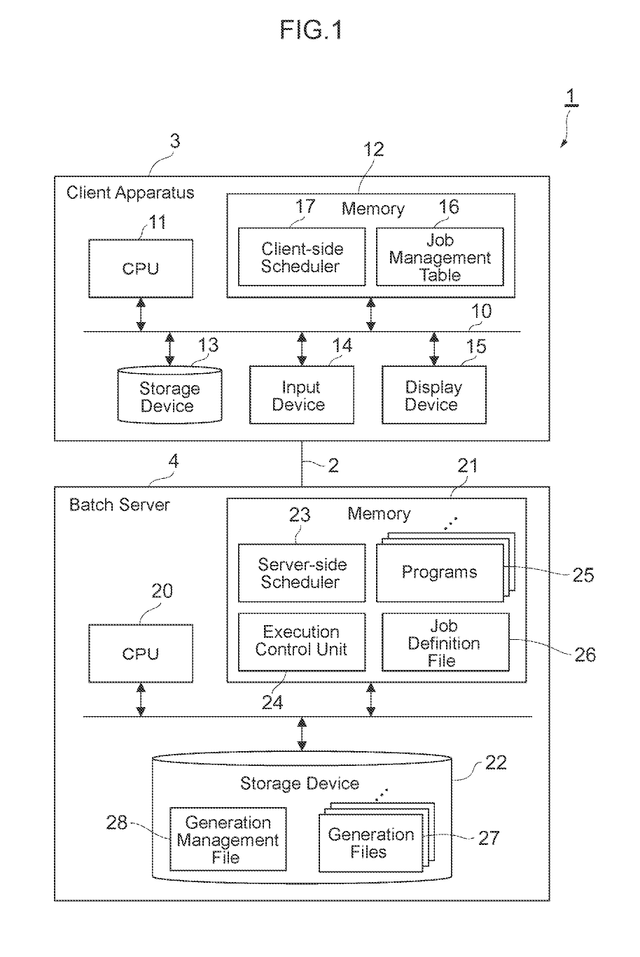

Referring to FIG. 1, 1 represents an information processing system according to this embodiment as a whole. This information processing system 1 is configured of a client apparatus 3 and a batch server 4 which are connected via a communication path 2 such as a cable or a network.

The client apparatus 3 is a computer apparatus that manages each of a series of jobs constituting one processing sequence registered by a user and issues an instruction to the batch server 4 to execute any of the jobs on its execution date and time. This client apparatus 3 is configured by including a CPU (Central Processing Unit) 11, a memory 12, a storage device 13, an input device 14, and a display device 15 which are connected to each other via an internal bus 10.

The CPU 11 is a processor that controls the operation of the entire client apparatus 3. Moreover, the memory 12 is composed of, for example, a volatile semiconductor memory and is used as a work memory of the CPU 11. A job management table 16 and a client-side scheduler 17 which will be described later are stored and retained in this memory 12.

The storage device 13 is composed of, for example, hard disk drives and is used to retain programs and data for a long period. The programs stored in the storage device 13 are read to the memory 12 and executed by the CPU 10 at the time of activation of the client apparatus 3 or whenever necessary, thereby executing various kinds of processing as the entire client apparatus 3.

The input device 14 is composed of a keyboard, a mouse, and so on and is used, for example, when the user creates an execution schedule of a series of jobs. Furthermore, the display device 15 is composed of, for example, a liquid crystal panel display and displays various kinds of GUI's (Graphical User Interfaces) and various kinds of necessary information in accordance with instructions from the CPU 11.

The batch server 4 is a server apparatus that executes designated batch processing by inputting the latest generation file in response to a request from the client apparatus 3 and is configured by including a CPU 20, a memory 21, and a storage device 22. Since the CPU 20, the memory 21, and the storage device 22 have the same configurations and functions as those of the CPU 11, the memory 12, and the storage device 13 for the client apparatus 3, any description about them has been omitted here.

The memory 21 for the batch server 4 stores, as programs, a server-side scheduler 23 and an execution control unit 24 and programs 25 for the respective jobs, which will be described later, and stores a job definition file 26 as control data.

The job definition file 26 is a file in which job content of each file, such as the program 25 to be activated when executing a job, a generation file to be input when executing the job, and a generation file to output the processing result of the job, is defined.

Furthermore, operations of the batch server 4 to be executed when the generation file in which the processing result of the relevant job is recorded already exists (that is, when the job is being re-executed and the generation file created by executing that job last time exists) are recorded with respect to each job in the job definition file 26.

In a case of this embodiment, the following three operations are defined as the above-described operations: “overwrite” to overwrite the back processing result obtained by re-execution of the job with the generation file which already exists; “save” to associate a generation file, which is newly created in place of the already-existing generation file, with its corresponding generation and record the batch processing result, which is obtained by re-executing the job, in the new generation file; and “abort” to abort the re-execution of the job. Incidentally, in the case of “save,” another file name which is different from the file name assigned to the generation file of the corresponding generation is assigned to the already-existing generation file and then stored.

Meanwhile, the storage device 22 for the batch server 4 stores: the generation files 27 of the respective generations in which the processing results of the batch processing are recorded; and a generation management file 28 used to manage the generation files 27 of the respective generations. The details of the generation management file 28 will be described later.

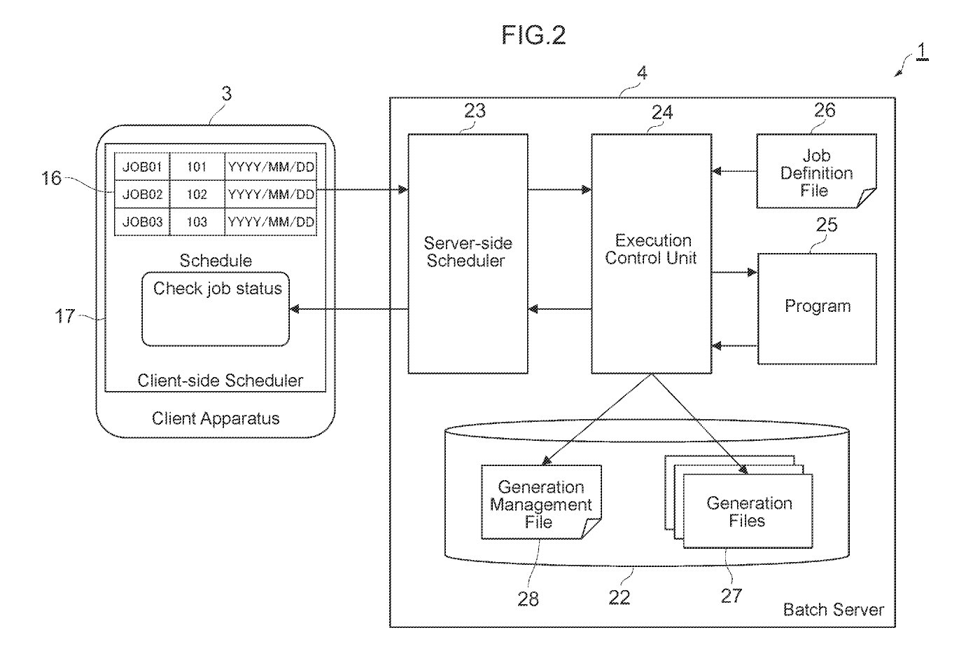

FIG. 2 illustrates a logical configuration of the client apparatus 3 and the batch server 4. The client apparatus 3 is equipped with the client-side scheduler 17 and the batch server 4 is equipped with the server-side scheduler 23, the execution control unit 24, and the program 25 as illustrated in this FIG. 2.

The client-side scheduler 17 is a program having a function that manages a series of jobs registered by the user; and displays a specified GUI screen for registering the jobs on the display device according to the user's operation and stores and manages the jobs registered by the user in the job management table 16 by using the relevant GUI.

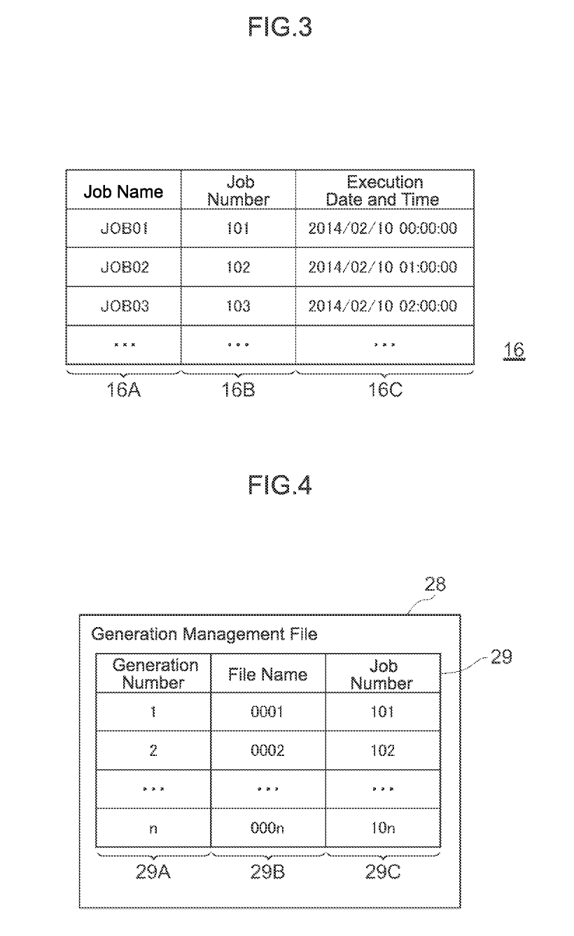

The job management table 16 is composed of a job name column 16A, a job number column 16B, and an execution date and time column 16C as illustrated in FIG. 3. Then, the job name column 16A stores the name assigned to the registered job by the user (job name) and the execution date and time column 16C stores a scheduled execution date and time of the relevant job.

Furthermore, the job number column 16B stores the job number assigned by the client-side scheduler 17 at the time of registration of the relevant job. The job number is an identification number which is set based on the job name and execution date and time of the registered job and is specific to the relevant job; and when the same job is executed more than once and on different execution dates and times, different job numbers are assigned to the respective jobs. Moreover, the job number will not be changed when re-executing the job.

Then, when the execution date and time of any of the jobs which are managed come, the client-side scheduler 17 transmits a request to activate the relevant job (hereinafter referred to as the job boot request) and the job number of that job to the server-side scheduler 23 for the batch server 4.

The server-side scheduler 23 is a program having a function that mediates exchanges of commands and information between the client-side scheduler 17 for the client apparatus 3 and the execution control unit 24 for the batch server 4. After receiving the job boot request and the job number from the client-side scheduler 17, the server-side scheduler 23 transfers them to the execution control unit 24.

The execution control unit 24 is a program having a function that controls execution of the designated job in response to the job boot request from the client-side scheduler 17. After receiving the job boot request and the job number transferred from the server-side scheduler 23, the execution control unit 24 refers to the job definition file 26 and determines a program 25 to be activated in order to execute the designated job, a generation file 27 to be input for that job and a generation file 27 to be output, and operation to be executed when the generation file 27 corresponding to the reported job number already exists.

Furthermore, the execution control unit 24 refers to the generation management file 28 stored in the storage device 22 and checks whether the generation file 27 of the generation corresponding to the job number reported from the client-side scheduler 17 has already been created or not.

This generation management file 28 is a file used by the execution control unit 24 to manage generation files 27 of the respective generations which have already been created and stored in the storage device 22. A table 29 composed of a generation number column 29A, a file name column 29B, and a job number column 29C is recorded in this generation management file 28 as illustrated in FIG. 4.

Then, the generation number column 29A of the relevant table 29 stores the number assigned to the corresponding generation (generation number). In a case of this embodiment, regarding the generation number, “1” is assigned to the latest generation; and regarding generations prior to the latest generation, a value obtained by sequentially adding “1” to the generation number of the latest generation is assigned to the generation number of the relevant previous generation as the generation becomes one generation older. Furthermore, the file name column 29B stores the file name assigned to the generation file 27, regarding which the processing result of the corresponding generation is recorded; and the job number column 29C stores the job number assigned to the job processing of the corresponding generation.

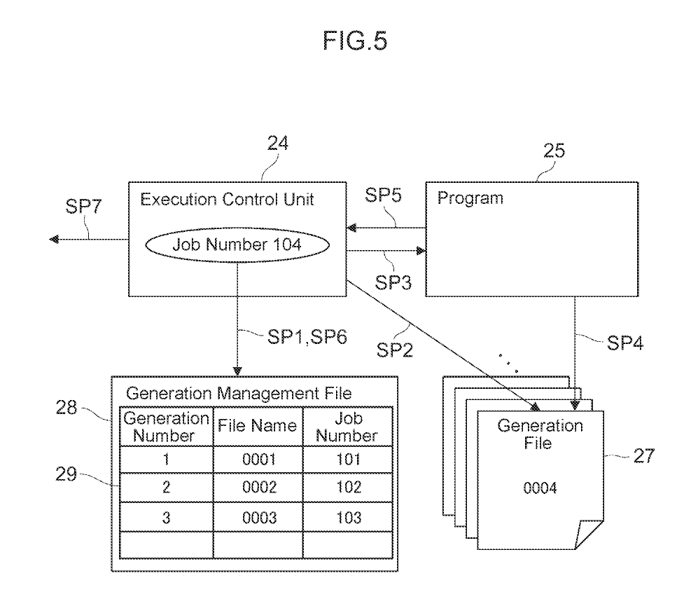

Accordingly, as illustrated in FIG. 5, the execution control unit 24 searches the generation management file 28 for the job number reported from the client-side scheduler 17 (SP1); and if the execution control unit 24 fails to detect the job number (that is, if the generation file 27 corresponding to the relevant job number does not exist), it determines that the job is not being re-executed, and creates a generation file 27 of that generation and stores the created generation file 27 in the storage device 22 (SP2), and also activates the corresponding program 25 (SP3).

As a result, the program 25 activated by the execution control unit 24 executes the corresponding batch processing and records the processing result in the above-described newly-created generation file 27 (SP4). Furthermore, when the program 25 terminates the batch processing, it transmits a code to that effect (hereinafter referred to as the job end code) to the execution control unit 24 (SP5).

Therefore, after receiving the job end code, the execution control unit 24 updates the generation management file 28 (SP6) and transmits the relevant job end code to the client-side scheduler 17 (FIG. 2) via the server-side scheduler 23 (FIG. 2) (SP7).

On the other hand, when the execution control unit 24 detects the job number, which has been reported from the client-side scheduler 17, in the generation management file 28 (that is, when the generation file 27 corresponding to that job number already exists), it determines that the job is being re-executed, and executes the operation defined in the job definition file 26 as the operation to be executed in that case (“overwrite,” “save,” or “abort”).

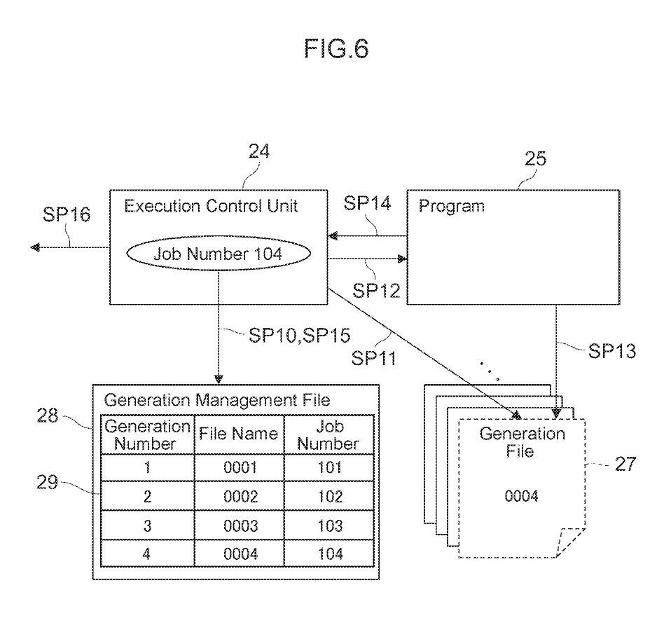

For example, when “overwrite” or “save” is defined in the job definition file 26 as such operation and the execution control unit 24 detects the job number, which has been reported from the client-side scheduler 17, in the generation management file 28 as illustrated in FIG. 6 (SP10) and if such operation is to “overwrite,” the execution control unit 24 deletes the generation file 27 corresponding to that job number from the storage device 22, creates a new generation file 27 corresponding to the generation of the relevant job number, and stores it in the storage device 22; and if such operation is to “save,” the execution control unit 24 saves the generation file 27 which corresponds to that job number and is stored in the storage device 22, then creates a new generation file 27 corresponding to the generation of the relevant job number, and stores it in the storage device 22 (SP11). Subsequently, the execution control unit 24 activates the corresponding program 25 (SP12).

As a result, the program 25 activated by the execution control unit 24 executes the corresponding batch processing and records its processing result in the above-mentioned newly-created generation file 27 (SP13). Furthermore, when the program 25 terminates the batch processing, it transmits a code to that effect (hereinafter referred to as the job end code) to the execution control unit 24 (SP14).

Therefore, after receiving the job end code, the execution control unit 24 updates the generation management file 28 (SP15) and also transmits that job end code to the client-side scheduler 17 via the server-side scheduler 23 (SP16).

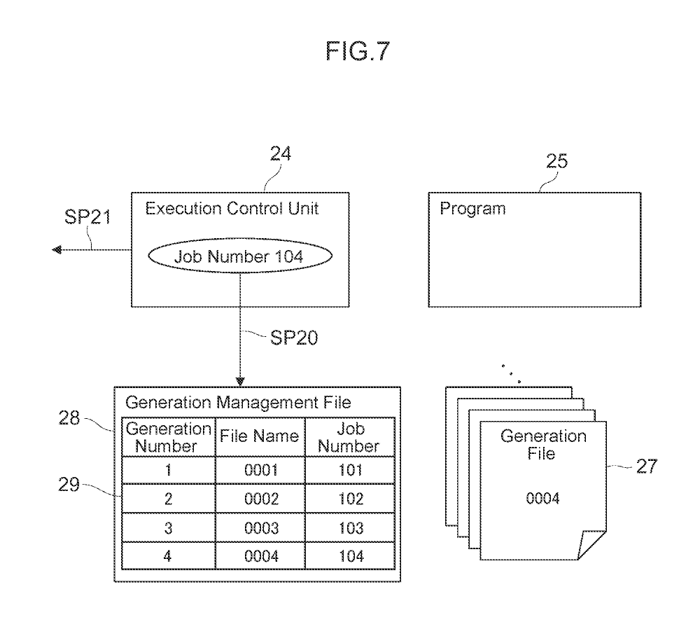

Meanwhile, when “abort” is defined in the job definition file 26 as such operation and the execution control unit 24 detects the job number, which has been reported from the client-side scheduler 17, in the generation management file 28 as illustrated in FIG. 7 (SP20), it transmits a job end code to that effect to the client-side scheduler 17 via the server-side scheduler 23 (SP21).

Incidentally, the information processing system 1 according to this embodiment is also equipped with a function that allows the user to designate the operation of the batch server 4 every time a job, regarding which the generation file 27 is already stored in the storage device 22 of the batch server 4 as described above, is re-executed (hereinafter referred to as the user response function).

Practically, when the user response function is set to ON and if the execution control unit 24 for the batch server 4 detects the job number, which has been reported from the client-side scheduler 17, in the generation management file 28, the execution control unit 24 transmits a message to that effect (hereinafter referred to as the response request message) to the client apparatus 3 via the server-side scheduler 23.

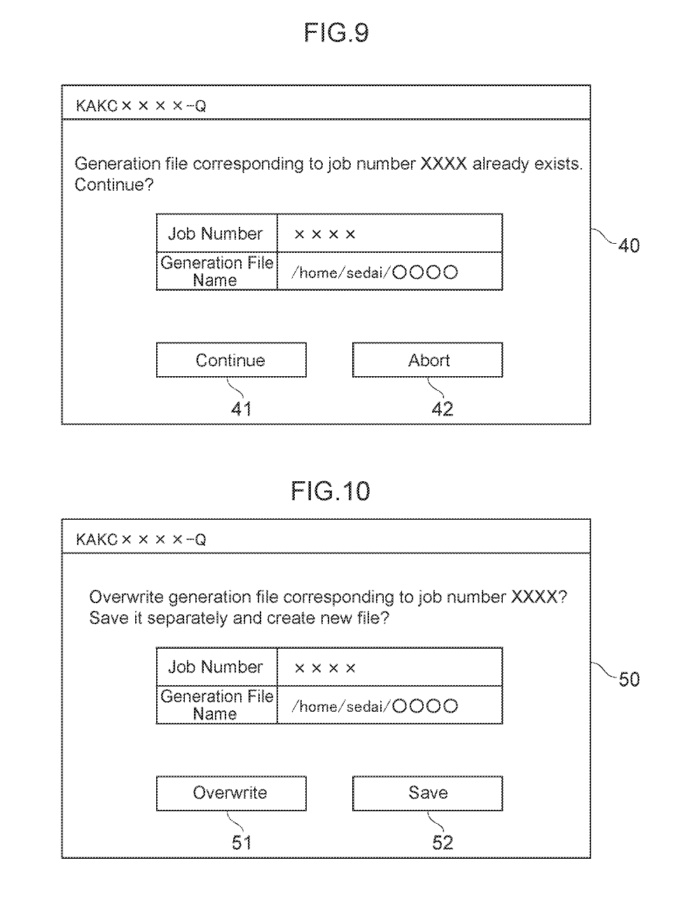

Then, having received this response request message, the client-side scheduler 17 for the client apparatus 3 displays a first operation check window 40 and a second operation check window 50, which will be described later with reference to FIG. 9 and FIG. 10, on the display device 15 (FIG. 1) in order to check with the user which one of the operations “overwrite,” “save,” and “abort” should be executed as the subsequent operation of the batch server 4. Then, when the operation which should be then executed by the batch server 4 is designated by the user by using the first operation check window 40 and the second operation check window 50, the client-side scheduler 17 transmits a message indicative of the designated operation (hereinafter referred to as the response message) to the batch server 4.

Therefore, this response message is given to the execution control unit 24 via the server-side scheduler 23 in the batch server 4. Then, if such operation is to either “overwrite” or “save,” the execution control unit 24 which has received this response message executes the processing in step SP11 and subsequent steps of the series of processing described earlier with reference to FIG. 6; and if such operation is to “abort,” the execution control unit 24 executes the processing in step SP21 and subsequent steps of the series of processing described earlier with reference to FIG. 7.

In a case of this embodiment, whether the processing based on such user response function is to be executed or not is defined in the job definition file 26.

### (2) Various Kinds of Screens Displayed on Client Apparatus

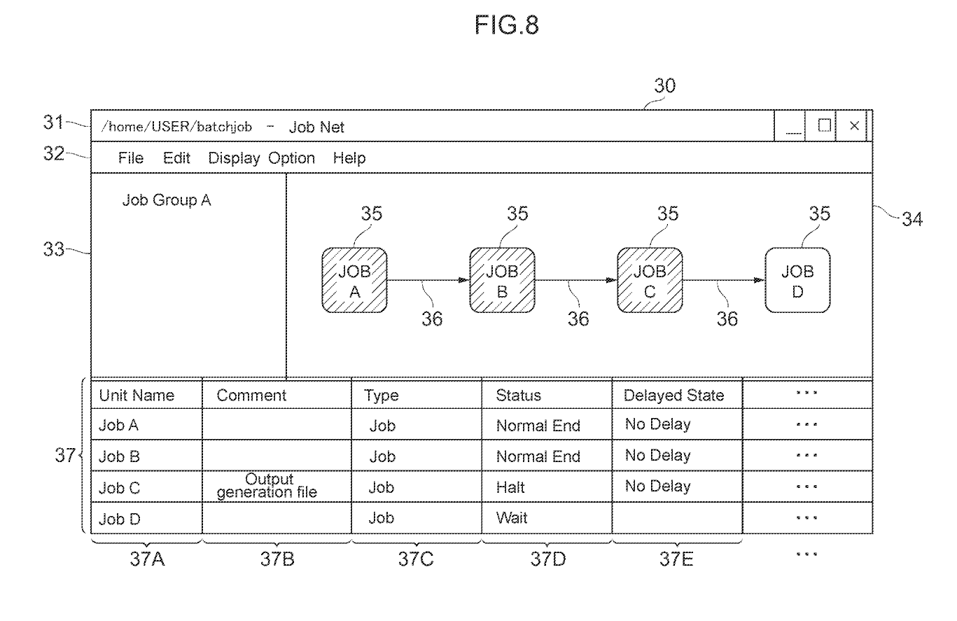

FIG. 8 illustrates the structure of a job net screen 30 displayed on the display device 15 for the client apparatus 3 when the batch server 4 in the information processing system 1 according to this embodiment executes the processing composed of a series of jobs.

The job net screen 30 is provided with a screen name display bar 31 and a tool bar 32 at the top of the screen, a job group name display section 33 on the lower left of the tool bar 32, and a job net display section 34 on the lower right of the tool bar 32, respectively, as illustrated in FIG. 8.

Then, the job group name display section 33 displays the name assigned to a job group composed of a series of jobs which are being executed by the batch server 4 at that time (job group name).

Furthermore, the job net display section 34 displays: marks which display job names of these jobs, respectively, corresponding to the respective jobs belonging the relevant job group (hereinafter referred to as the job mark(s)) 35 arranged in the order of execution from the left to the right; and arrows 36 pointing to the right between the respective job marks 35.

Then, the job net display section 34 displays a job mark 35 corresponding to a job whose processing has been completed or a job mark 35 corresponding to a job whose processing has been aborted or halted by changing its color from that of a job mark 35 corresponding to a job whose processing has not been completed.

Furthermore, a job detail list 37 is displayed below the job group name display section 33 and the job net display section 34. This job detail list 37 is composed of, for example, a unit name column 37A, a comment column 37B, a type column 37C, a status column 37D, and a delayed state column 37E; and the job names of the respective jobs belonging to the then-targeted job group (the job group whose group name is displayed in the job group name display section 33) are displayed respectively in the unit name column 37A.

Furthermore, the comment column 37B displays information about the relevant job which is input in advance (for example, “output generation file” in a case of a job to output the generation file 27); and the type column 37C displays the type of the relevant job. Furthermore, the status column 37D displays the status of the relevant job (such as “Normal End,” “Halt,” or “Wait”); and the delayed state column 37E displays information about a delayed state of the relevant job.

Accordingly, in the case of the example of FIG. 8, it is shown that: the job group executed by the batch server 4 at that time is “Job Group A”; “Job Group A” is composed of four jobs “Job A,” “Job B,” “Job C,” and “Job D”; and at the stage when “Job C” among these jobs is completed, a generation file 27 is output (“output generation file”). Furthermore, FIG. 8 shows that, regarding “Job A” to “Job D,” the processing of “Job A” and “Job B” has already normally terminated (“Normal End”) and “Job C” is in the “Halt” state.

Incidentally, FIG. 8 illustrates a display example of the job net screen 30 in a case where the user response function is set to ON in the job definition file 26 and it is confirmed, when executing “Job C,” that the generation file 27 of the corresponding generation already exists. In this case, the display device 15 for the client apparatus 3 displays the first operation check window 40 as illustrated in FIG. 9 over the job net screen 30.

This first operation check window 40 displays a message indicating that the generation file 27 corresponding to the job in the halt state already exists (“Generation file corresponding to job number XXXX already exists”), and a message to inquire whether to continue that job or not (“Continue?”), as well as the job number of that job and the file name of the already-existing generation file.

Furthermore, the first operation check window 40 displays a continue button 41 and an abort button 42. Then, the user can designate “abort” as subsequent operation of the batch server 4 by clicking the abort button 42 and can designate “continue” (that is, “overwrite” or “save”) as the subsequent operation of the batch server 4 by clicking the continue button 41. Then, when the continue button 41 is clicked, the second operation check window 50 as illustrated in FIG. 10, instead of the first operation check window 40, is displayed over the job net screen 30.

When continuing the relevant job, this second operation check window 50 displays a message to inquire whether to overwrite the processing result of the relevant job with the corresponding already-existing generation file or to save the already-existing generation file and write data to a new generation file (“Overwrite generation file corresponding to job number XXXX? Save it separately and create new file?”), and also displays the job number of the job and the file name of the already-existing generation file.

Furthermore, the second operation check window 50 displays an overwrite button 51 and a save button 52. Then, the user can designate “overwrite” as subsequent operation of the batch server 4 by clicking the overwrite button 51 and can designate “save” as the subsequent operation of the batch server 4 by clicking the save button 52.

### (3) Various Kinds of Processing Relating to Batch Processing

Next, specific processing content of various kinds of processing executed in relation to the above-described batch processing will be explained. Incidentally, in the following explanation, a “program” will be described as a processing subject of the various kinds of processing and it is a matter of course that the processing will be executed by the CPU 11 for the client apparatus 3 or the CPU 20 for the batch server 4 based on the “program.”

(3-1) Processing by Client-side Scheduler

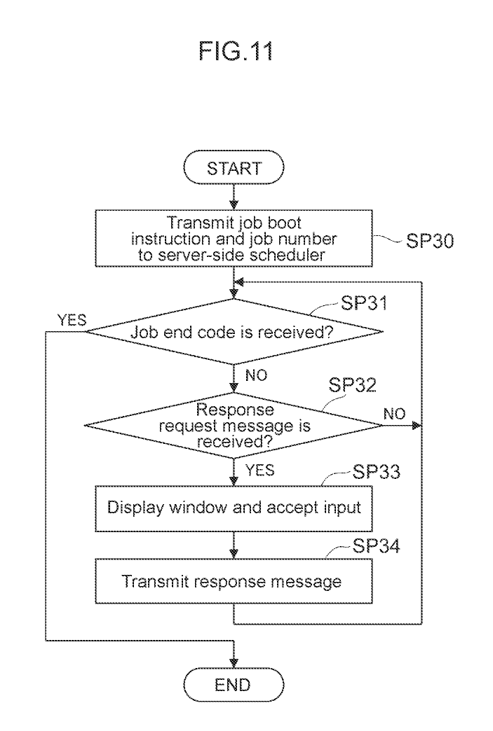

FIG. 11 illustrates a processing sequence for job boot processing executed by the client-side scheduler 17 (FIG. 2). In the following explanation, the processing for displaying the job net screen 30 as described with reference to FIG. 8 will be omitted.

When the execution date and time of any one of jobs registered in the job management table 16 (FIG. 3) come, the client-side scheduler 17 starts the job boot processing illustrated in this FIG. 11 and firstly reads the job number of the job from the job management table 16 and transmits the read job number together with a job boot request to the batch server 4 (SP30).

Subsequently, the client-side scheduler 17 waits for a job end code or a response request message to be transmitted from the batch server 4 (SP31, SP32). Then, after receiving the response request message (SP32: YES), the client-side scheduler 17 displays the first operation check window 40 described earlier with reference to FIG. 9 and, if necessary, the second operation check window 50 described earlier with reference to FIG. 10 on the display device 15 (FIG. 1) and then accepts operation input from the user (SP33).

Next, when the operation of the batch server 4 is designated by the user by using the first operation check window 40 and the second operation check window 50, the client-side scheduler 17 transmits the designated operation of the batch server 4 as a response message to the batch server 4 (SP34) and then returns to step SP31.

Furthermore, when the client-side scheduler 17 eventually receives the job end code from the batch server 4 (SP31: YES), it terminates this job boot processing.

(3-2) Processing by Server-Side Scheduler

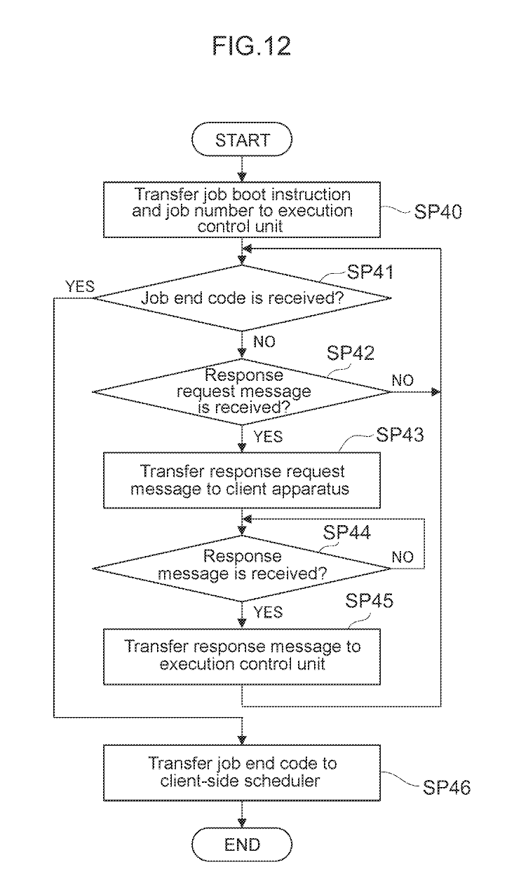

Meanwhile, FIG. 12 illustrates a processing sequence for job management processing executed by the server-side scheduler 23 (FIG. 2) for the batch server 4 which has received the job boot request and the job number from the client-side scheduler 17.

When the server-side scheduler 23 receives the job boot request and the job number, it starts the job management processing illustrated in this FIG. 12 and firstly transfers the received job boot request and job number to the execution control unit 24 (SP40).

Subsequently, the server-side scheduler 23 waits for the job end code or the response request message to be transmitted from the execution control unit 24 (SP41, SP42). Then, after receiving the response request message from the execution control unit 24 (SP42: YES), the server-side scheduler 23 transfers the response request message to the client apparatus 3 (SP43).

Next, the server-side scheduler 23 waits for the aforementioned response message (step SP34 in FIG. 11) for the response request message to be transmitted from the client apparatus 3 (SP44). Then, when the server-side scheduler 23 eventually receives this response message (SP44: YES), it transfers this response message to the execution control unit 24 (SP45) and then returns to step SP41.

Then, when the server-side scheduler 23 eventually receives the job end code from the execution control unit 24 (SP41: YES), it transfers the received job end code to the client-side scheduler 17 for the client apparatus 3 (SP46) and then terminates this job management processing.

(3-3) Processing by Execution Control Unit

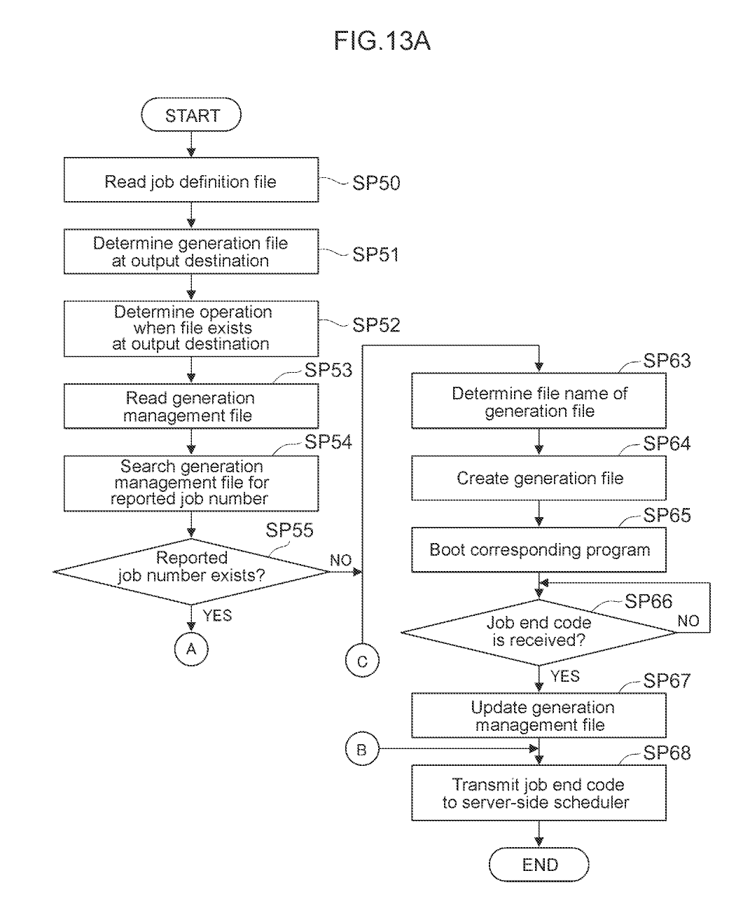

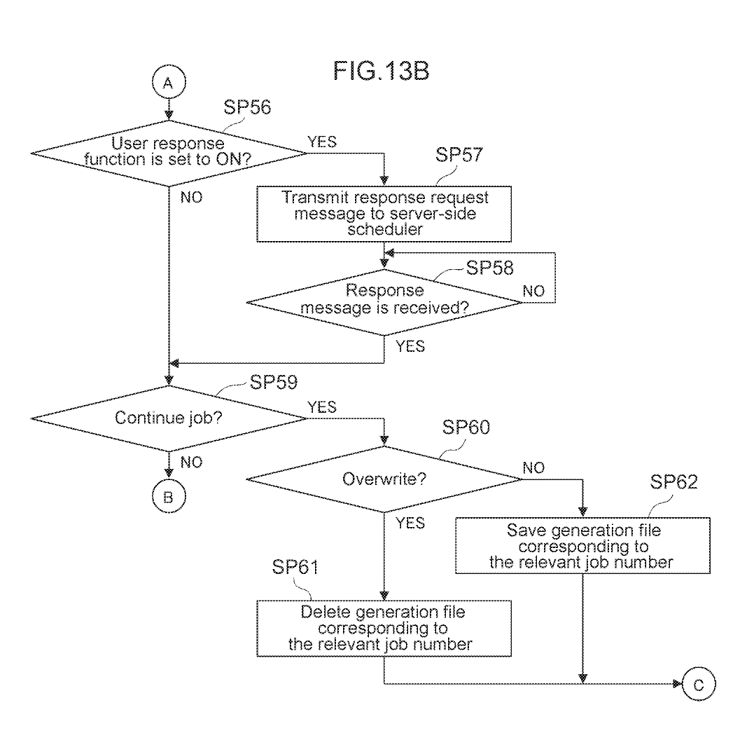

Meanwhile, FIG. 13A and FIG. 13B illustrate a processing sequence for job execution control processing executed by the execution control unit 24 which has received the job boot request and the job number from the server-side scheduler 23.

After receiving the job boot request and the job number, the execution control unit 24 starts the job execution control processing illustrated in FIG. 13A and FIG. 13B and firstly reads the job definition file 26 (SP51) and determines a generation file to output the processing result of the batch processing and the operation to be executed when the relevant generation file exists (overwrite, save, or abort, or user response), on the basis of the read job definition file 26 (SP52).

Subsequently, the execution control unit 24 reads the generation management file 28 (FIG. 4) (SP53) and searches the generation management file 28 for the job number reported from the server-side scheduler 23 (SP54). Then, the execution control unit 24 determines, based on this search result, whether a generation file 27 corresponding to the job number reported from the server-side scheduler 23 already exists or not (SP55).

If the execution control unit 24 obtains a negative result in this judgment, it determines a file name of the generation file 27 corresponding to the job number reported from the server-side scheduler 23 on the basis of that job number (SP63) and creates the generation file 27 with the determined file name (SP64).

Furthermore, the execution control unit 24 activates the corresponding program 25 in accordance with the job boot request from the server-side scheduler 23 (SP65) and then waits for the job end code to receive from the program 25 (SP66). Consequently, the then-activated program 25 executes the corresponding job; and when the job is terminated, the program 25 records the processing result in the generation file 27 created in step SP64 and transmits the job end code to the execution control unit 24.

Then, after receiving the job end code from the program 25, the execution control unit 24 newly registers the generation file 27 created in step SP64 in the generation management file 28, sets the generation number of the generation file 27 as “1,” updates the generation management file 28 to shift the generation number of each of generation files 27 with an older generation than that of the above-mentioned generation file 27 to a larger value by “1,” and registers the job number assigned to the job processing of the corresponding generation (SP67).

Subsequently, the execution control unit 24 transfers the job end code received from the program 25 in step SP66 to the server-side scheduler 23 (SP68) and then terminates this job execution control processing.

On the other hand, if the execution control unit 24 obtains an affirmative result in the judgment of step SP55, it refers to the job definition file 26 read in step SP50 and determines whether the user response function is set to ON or not (SP56).

Then, if the execution control unit 24 obtains an affirmative result in this judgment, it transmits a response request message to the server-side scheduler 23 (SP57) and then waits for a response message to receive from the client-side scheduler 17 (SP58).

Then, if the execution control unit 24 eventually receives the response message from the client-side scheduler 17 (SP58: YES), it determines whether or not the operation designated in the response message is either “overwrite” or “save” (SP59).

To obtain the negative result in this judgment means that the operation designated in the response message is to “abort.” Consequently, under this circumstance, the execution control unit 24 transmits the job end code, indicating that the relevant job has been aborted, to the server-side scheduler 23 (SP68); and then terminates this job execution control processing. As a result, in this case, a message indicating that the relevant job has been aborted is displayed on the display device 15 for the client apparatus 3.

Meanwhile, if the execution control unit 24 obtains an affirmative result in the judgment in step SP59, it determines whether the operation designated by the user is to “overwrite” or not, based on the response message received in step SP58 (SP60).

Then, if the execution control unit 24 obtains an affirmative result in this judgment, it deletes the generation file 27 which is stored in the storage device 22 (FIG. 2) at that time and corresponds to the job number reported from the client-side scheduler 17 (SP61). Subsequently, the execution control unit 24 executes the processing in step SP63 and subsequent steps as described above and then terminates this job execution control processing.

On the other hand, to obtain the negative result in the judgment in step SP60 means that the operation designated by the user is to “save.” Consequently, under this circumstance, the execution control unit 24 separates the job number which is stored in the storage device 22 at that time and reported from the client-side scheduler 17, from the corresponding generation file 27 (SP62). Specifically speaking, the execution control unit 24 changes the file name of the relevant generation file 27 and deletes an entry (line) corresponding to that generation file 27 in the generation management file 28. Subsequently, the execution control unit 24 executes the processing in step SP63 and subsequent steps as described above and then terminates this job execution control processing.

Meanwhile, if the execution control unit 24 obtains a negative result in the judgment in step SP56, it determines whether or not the operation which is set in the job definition file 26 as the operation to be executed when the generation file 27 associated with the job number reported from the client-side scheduler 17 already exists is either “overwrite” or “save” (SP59).

Then, if the execution control unit 24 obtains a negative result in this judgment, it transmits the job end code, indicating that the relevant job has been aborted, to the server-side scheduler 23 (SP68); and then terminates this job execution control processing. As a result, in this case, a message indicating that the relevant job has been aborted is displayed on the display device 15 for the client apparatus 3.

On the other hand, if the execution control unit 24 obtains an affirmative result in the judgment in step SP59, it determines whether or not the operation which is set in the job definition file 26 as the operation to be executed when the generation file 27 associated with the job number reported from the client-side scheduler 17 already exists is to “overwrite” (SP60).

Then, if the execution control unit 24 obtains an affirmative result in this judgment, it deletes the generation file 27 which is then stored in the storage device 22 (FIG. 2) and corresponds to the job number reported from the client-side scheduler 17 (SP61). Subsequently, the execution control unit 24 executes the processing in step SP63 and subsequent steps as described above and then terminates this job execution control processing.

Meanwhile, to obtain a negative result in the judgment in step SP60 means that the operation designated by the user is to “save.” Accordingly, in that case, the execution control unit 24 separates the generation file 27, which is then stored in the storage device 22 (FIG. 2) and corresponds to the job number reported from the client-side scheduler 17, from that job number (SP62). Subsequently, the execution control unit 24 executes the processing in step SP63 and subsequent steps as described above and then terminates this job execution control processing.

### (4) Advantageous Effects of this Embodiment

With the information processing system 1 according to this embodiment as described above, the batch server 4 manages jobs by associating the job number assigned to each job with a generation file 27 created by the job; and when executing a job, the batch server 4 determines whether the generation file 27 associated with the job number assigned to that job has already been created or not; and if the generation file 27 already exists, the batch server 4 executes the operation which is defined in the job definition file 26 in advance or designated by the user.

Therefore, this information processing system 1 can prevent unconditional creation of a new generation file 27 by re-executing a job, eliminate the costs of post-processing of invalid generation files caused by job errors or modification of a job execution plan, and shorten the time required to complete the processing composed of a series of jobs.

### (5) Other Embodiments

Incidentally, the aforementioned embodiment has described a case where the client apparatus 3 is equipped with a function as the job management unit for managing registered jobs and the batch server 4 is equipped with a function as the job execution unit for executing a designated job on the basis of a request to execute the job from the job management unit (the client apparatus 3); however, the present invention is not limited to this example and the batch server 4 may be equipped with all of the function as the job management unit and the function as the job execution unit.

Moreover, the aforementioned embodiment has described a case where three operations “overwrite,” “save,” and “abort” are applied as the operation to be executed when the generation file associated with the corresponding job number exists upon the execution of the job; however, the present invention is not limited to this example and other operation(s) may be applied in addition to or instead of the above-listed operations.

Furthermore, the aforementioned embodiment has described a case where the number (job number) is assigned as an identifier to an individual job; however, the present invention is not limited to this example and, for example, instead of the number (the job number), alphabets may be applied as the identifier of each job or a combination of alphabets and numbers may be applied as the identifier of each job.

### REFERENCE SIGNS LIST

1 information processing system; 3 client apparatus; 4 batch server; 11, 20 CPU; 12, 21 memory; 13, 22 storage device; 16 job management table; 17 client-side scheduler; 23 server-side scheduler; 24 execution control unit; 25 program; 26 job definition file; 27 generation file; 28 generation management file; 30 job net screen; and 40, 50 operation check window.

1. An information processing method for an information processing system which creates, by inputting a generation file of a latest generation and executing a job, a generation file of a next generation,
the information processing system comprising:
a job management unit that manages the job registered; and
a job execution unit that executes the job designated on the basis of a request to execute the job from the job management unit,
the information processing method comprising:
a first step executed by the job management unit managing the registered job by associating the job with an identifier specific to the job and reporting a request to execute the job and the identifier associated with the job to the job execution unit on an execution date and time of the job; and
a second step executed by the job execution unit executing the job designated on the basis of the request to execute the job from the job management unit and managing the generation file of the next generation created by executing the job by associating the generation file with the identifier reported together with the request to execute the job from the job management unit;
wherein in the second step, the job execution unit
checks, when executing the job on the basis of the execution request from the job management unit, whether the generation file associated with the identifier reported together with the execution request already exists or not;
executes the designated job if the generation file does not exist; and
executes designated operation if the generation file already exists.

2. The information processing method according to claim 1,
wherein the operation of the job execution unit when the generation file associated with the identifier already exists is to overwrite a processing result of the job with the already-existing generation file associated with the identifier, or save the already-existing generation file associated with the identifier and create the generation file new, or abort the execution of the job.

3. The information processing method according to claim 2,
wherein the job execution unit retains a job definition file which defines job content of each job;
the job execution unit
refers to the job definition file and executes the job every time the request to execute the job is given from the job management unit; the operation of the job execution unit, when the generation file associated with the identifier already exists, being defined in the job definition file; and
determines, based on the defined operation, whether to overwrite the processing result of the job with the already-existing generation file associated with the identifier, or save the already-existing generation file associated with the identifier and create the generation file new, or abort the execution of the job.

4. The information processing method according to claim 2,
wherein in the second step,
the job execution unit transmits a specified message to the job management unit if the generation file associated with the identifier reported together with the execution request already exists when executing the job on the basis of the execution request from the job management unit;
the job management unit displays, when the job management unit receives the message from the job execution unit, a request to input operation to be executed by the job execution unit and notifies the job execution unit of the operation which is input and is to be executed by the job execution unit; and
the job execution unit executes the operation notified of by the job management unit.

5. An information processing system which creates, by inputting a generation file of a latest generation and executing a job, a generation file of a next generation,
the information processing system comprising:
a job management unit that manages the job which is registered; and
a job execution unit that executes the job designated on the basis of a request to execute the job from the job management unit,
wherein the job management unit manages the registered job by associating the job with an identifier specific to the job and reports a request to execute the job and the identifier associated with the job to the job execution unit on an execution date and time of the job; and
wherein the job execution unit manages the generation file of the next generation created by executing the job by associating the generation file with the identifier reported together with the request to execute the job from the job management unit; and, the job execution unit checks, when executing the job on the basis of the execution request from the job management unit, whether the generation file associated with the identifier reported together with the execution request already exists or not; and the job execution unit executes the designated job if the generation file does not exist; and the job execution unit executes designated operation if the generation file already exists.

6. The information processing system according to claim 5,
wherein the operation of the job execution unit when the generation file associated with the identifier already exists is to overwrite a processing result of the job with the already-existing generation file associated with the identifier, or save the already-existing generation file associated with the identifier and create the generation file new, or abort the execution of the job.

7. The information processing system according to claim 6,
wherein the job execution unit retains a job definition file which defines job content of each job;
the job execution unit
refers to the job definition file and executes the job every time the request to execute the job is given from the job management unit; the operation of the job execution unit, when the generation file associated with the identifier already exists, being defined in the job definition file; and
determines, based on the defined operation, whether to overwrite the processing result of the job with the already-existing generation file associated with the identifier, or save the already-existing generation file associated with the identifier and create the generation file new, or abort the execution of the job.

8. The information processing system according to claim 6,
wherein if the generation file associated with the identifier reported together with the execution request already exists when executing the job on the basis of the execution request from the job management unit, the job execution unit transmits a specified message to the job management unit;
the job management unit displays, when the job management unit receives the message from the job execution unit, a request to input operation to be executed by the job execution unit and notifies the job execution unit of the operation which is input and is to be executed by the job execution unit; and
the job execution unit executes the operation notified of by the job management unit.
